(19) United States
(12) Patent Application Publication
(10) Pub. No.: US 2013/0088099 A1
(43) Pub. Date: Apr. 11, 2013

(54) Generator and Electricity-Generating System

(71) Applicants: Yasuaki Aoyama, Hitachinaka (JP); Yoshitaka Iwaji, Hitachinaka (JP)

(72) Inventors: Yasuaki Aoyama, Hitachinaka (JP); Yoshitaka Iwaji, Hitachinaka (JP)

(73) Assignee: Hitachi, Ltd., Chiyoda-ku, Tokyo (JP)

(21) Appl. No.: 13/702,516

(22) PCT Filed: Jun. 9, 2010
(86) PCT No.: PCT/JP2010/003825

§ 371 Date: Dec. 6, 2012

(51) Int. Cl. H02K 35/02

(52) U.S. Cl. CPC H02K 35/02
USPC 310/12.12

(57) ABSTRACT

To provide a linear generator according to the present invention where a load onto a supporting mechanism and the ripple of force are reduced, the pitch of a magnetic pole is narrowed and a high frequency is acquired, the linear generator according to the present invention is provided with plural magnetic poles arranged with the magnets arranged on a mover held between the plural magnetic poles, a core that continuously connects the magnetic poles which hold the magnets of the mover between them, winding integrally wound onto the plural magnetic poles and the mover configured by a row of magnets in which the magnetic poles of the magnets are alternately arranged or a row of magnets in which the polarity of magnets is alternately arranged and magnetic materials, the magnetic pole arranged with the magnets held between the magnetic poles and the magnetic pole provided with the core that continuously connects the magnetic poles which hold the magnets are arranged in a longitudinal direction of the mover by plural pieces, and common winding is arranged on the plural magnetic poles.

### TECHNICAL FIELD

The present invention relates to a linear generator and an electricity-generating system using it.

### BACKGROUND ART

To convert the energy of a reciprocating motion to electric energy, methods including a method of converting the reciprocating motion to rotation and driving a rotary generator and a method of converting the reciprocating motion to heat and fluid energy and driving a turbine generator are adopted.

However, as rotation or heat and fluid energy are converted to electric energy after the reciprocating motion is converted to the rotation and is converted to the heat and the fluid energy in the methods, conversion is repeated, loss increases, and a system is large-sized.

Besides, to enhance the efficiency of power generation, it is effective that an interval between magnetic poles is narrowed, a frequency is increased and voltage is raised. Then, in rotary electric equipment, a rotary machine effectively utilizing a transverse magnetic flux is disclosed in a patent literature 1. According to this patent literature, the quantity of electromagnetic coupling around a motor is reduced and the deterioration of the performance of the equipment can be inhibited.

Further, it is disclosed in the patent literature 1 that magnetic circuit configuration disclosed in the patent literature is applied to a linear generator.

According to a nonpatent literature 1, a generator using a transverse magnetic flux is proposed. According to the disclosed configuration, the same poles of permanent magnets are arranged with the same poles opposite and a magnetic flux concentrating member is arranged between the permanent magnets. On the adjacent side, the magnet and the magnetic flux concentrating member are arranged to be reverse polarity. A C-type stator core is arranged with the stator core holding the magnet and the magnetic flux concentrating member between is arranged and a stator coil is arranged in the center of the C-type stator core.

### CITATION LIST

### Patent Literature

Patent Literature 1: Japanese Patent No. 3645663

### Nonpatent Literature

Nonpatent Literature 1: “Conventional and TFPM Linear Generators for Direct-Drive Wave Energy Conversion,” IEEE Transactions on Energy Conversion, vol. 20, no. 2, June 2005.

### SUMMARY OF INVENTION

### Technical Problem

The above-mentioned technique has the following problem. The upper and lower stator cores are arranged with that a member configured by magnets held between them and are shifted by the pitch of the magnet. Therefore, at an end of transverse magnetic flux-equipment, only the upper or lower stator core exists and attraction between the magnet and the stator core grows.

Any mechanical support is required on the side of the member configured by magnets or when the side of the core is movable. A problem that a load onto a supporting mechanism grows by the attraction between the magnet and the stator core and the repairing and the maintenance of the supporting mechanism are required occurs.

Further, as the outermost stator core has no magnetic circuit outside the stator core, the stator core also has a problem that a magnetic circuit varies by an effect of an end and the ripple of force is caused.

An object of the present invention is to provide a linear generator where a load onto a supporting mechanism and the ripple of force are reduced, the pitch of a magnetic pole is narrowed and a frequency can be increased so as to settle the problems.

### Solution to Problem

The linear generator according to the present invention is provided with plural magnetic poles arranged with magnets arranged on a mover held between the plural magnetic poles, a core that continuously connects the magnetic poles which hold the magnets of the mover between, winding integrally wound onto the plural magnetic poles and the mover configured by a row of magnets in which the magnetic poles of the magnets are alternately arranged or a row of magnets in which the polarity of the magnets is alternately arranged and magnetic materials, plural magnetic poles arranged with the magnets held between and plural magnetic poles provided with the core that continuously connects magnetic poles which hold the magnets between are arranged in a longitudinal direction of the mover, and the common winding is arranged on the plural magnetic poles.

A leakage flux between the magnetic poles is reduced by making the polarity of the plural magnetic poles the same, as a result, an interval between the poles can be narrowed, and a frequency can be increased.

Further, the effect of the end is reduced by shifting positions of the magnetic poles that hold the magnets between, and the ripple of force and a load onto the supporting mechanism can be reduced. Furthermore, double or more movers are provided in a direction perpendicular to a traveling direction of the mover and as a result, attraction that causes the ripple of force and a load onto the supporting mechanism can be offset.

Besides, the linear generator according to the present invention is provided with a mover configured by magnets or magnets and a magnet holder, plural magnetic poles arranged with the mover held between the plural magnetic poles, a core that connects the plural magnetic poles and winding arranged on the plural magnetic poles.

In addition, the linear generator according to the present invention has structure that the mover pierces a stator configured by the core that connects the magnetic pole and the magnetic pole, space that pierces in the traveling direction of the mover is provided to the magnetic circuit, and an opening is provided to the magnetic circuit configured by the core that connects the magnetic pole and the magnetic pole.

Further, in the linear generator according to the present invention, the stator configured by the core that connects the magnetic pole and the magnetic pole and the winding is fixed and the mover configured by the magnets and the magnet holder is moved. Or the mover is fixed and the stator is moved.

### Advantageous Effects of Invention

For the effects of the present invention, a load onto the supporting mechanism of the mover is reduced by offsetting attraction that acts on the mover and the moment. Besides, the adjustment of ripples is facilitated by shifting upper and lower cores for the mover. According to the effects of the present invention, the linear generator where an interval between the magnetic poles is narrowed by making the polarity of the plural magnetic poles the same, efficient power generation is also enabled at a short stroke of reciprocation and a load onto the supporting mechanism of the mover is reduced can be provided.

### BRIEF DESCRIPTION OF DRAWINGS

FIG. 1 is a schematic representative diagram showing a linear generator equivalent to a first embodiment of the present invention;

FIG. 2 are schematic diagrams showing a generating unit in a modified example of the first embodiment of the present invention, FIG. 2A is a front view, FIG. 2B is a schematic perspective view, and FIG. 2C is a schematic side view;

FIG. 3 shows a generating unit equivalent to a second embodiment of the present invention;

FIG. 4 is a schematic diagram showing the generating unit equivalent to the second embodiment of the present invention and cut on a Y-Z plane;

FIG. 5 is a schematic diagram showing a generating unit in a modified example 1 of the second embodiment of the present invention;

FIG. 6 is a schematic diagram showing a generating unit in a modified example 2 of the second embodiment of the present invention;

FIG. 7 shows an example in which a core that connects magnetic poles is divided;

FIG. 8 shows an example in which a laminated member is used;

FIG. 9 shows an example in which a laminated member is divided;

FIG. 10 shows an example in which movers are coupled;

FIG. 11 are sectional views showing examples of the configuration of generating units;

FIG. 12 show transformed examples of magnetic poles or/and cores that connect magnetic poles;

FIG. 13 shows an example in which the number of laminated steel plates is changed;

FIG. 14 are schematic diagrams showing a third embodiment of the present invention, FIG. 14A is a sectional view, and FIGS. 14B and 14C are perspective views;

FIG. 15 shows an example in which movers in the third embodiment of the present invention are coupled;

FIG. 16 shows an example of the configuration of a three-phase linear generator;

FIG. 17 shows examples of a magnetic flux of the linear generator;

FIG. 18 shows an example of the arrangement of winding;

FIG. 19 show an example 1 of the configuration of the mover;

FIG. 20 show an example 2 of the configuration of the mover;

FIG. 21 shows an example in which a linear generator is coupled to a tire;

FIG. 22 show examples of wave activated generators;

FIG. 23 shows an example of the configuration of an electricity-generating system; and

FIG. 24 shows an example of the configuration of a second electricity-generating system.

### DESCRIPTION OF EMBODIMENTS

Embodiments of the present invention will be described below.

### First Embodiment

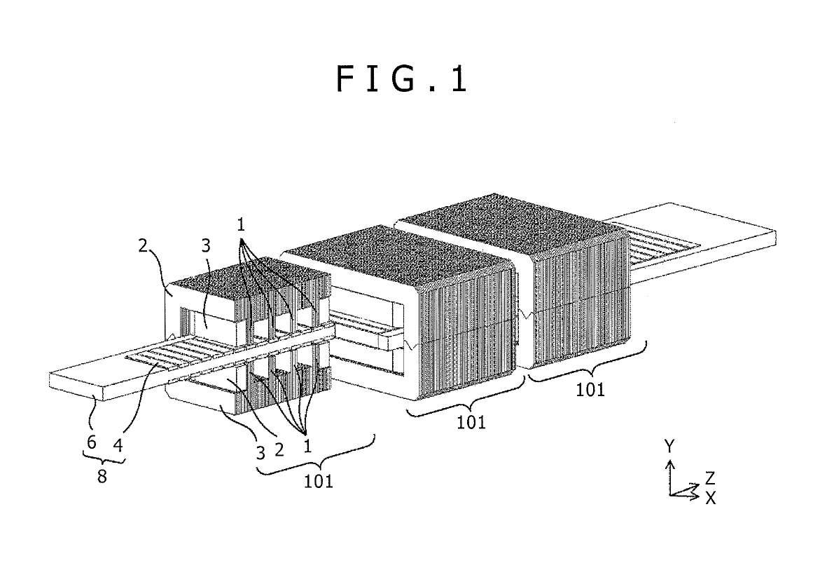

An embodiment of the present invention will be described below. FIG. 1 is a schematic diagram showing the first embodiment. FIG. 1 shows a three-phase linear generator according to the present invention. A generating unit 101 shown on this side in FIG. 1 of the linear generator configured by three generating units 101 is cut on a Y-Z plane so as to disclose the inside.

The linear generator according to the present invention is formed by a stator configured by a magnetic pole 1, a core 2 that connects plural magnetic poles and winding 3 wound onto the plural magnetic poles and a mover 8 configured by a magnet 4 and a magnet holder 6. The core 2 that connects the magnetic poles is vertically divided. The core that connects divided magnetic poles is divided in a position in which an upper member and a lower member have the same shape to enable configuring by the same members, however, a divided position is not limited to the position in which the upper and lower members have the same shape.

Besides, a triangular notch is provided to upper and lower joints of the core that connects upper and lower magnetic poles so as to facilitate alignment, however, the present invention is not limited to this shape. The upper and lower magnetic poles and the core that connects the magnetic poles can be relatively shifted by vertically dividing the core that connects magnetic poles.

The ripple of force generated in the mover 8 can be reduced by shifting the upper and lower magnetic poles and the core that connects the magnetic poles. Besides, the adjustment of force that acts on the mover is enabled by adjusting the shift.

In addition, the mover 8 is inserted with the mover piercing the magnetic pole 1 and the core 2 that connects magnetic poles. The magnetic pole 1 is configured by respective upper and lower four poles with the mover 8 configured by the magnet holder 6 and the plural magnets 4 held between. The number of the magnetic poles 1 is not limited to four. The magnetic pole 1 and the core 2 that connects magnetic poles are formed by a laminated member.

As a shifted and overhanged part is removed and can be installed on the reverse side to the shifted direction by forming by the laminated member when the upper and lower magnetic poles 1 and the core 2 that connects the magnetic poles are shifted, effect that adjustment is enabled without greatly changing a shape is acquired.

The generating unit 101 is laterally symmetrical when it is viewed on an X-Y plane and a magnetic circuit that a magnetic flux of the magnet 4 passes the upper magnetic pole 1 and returns to the magnet 4 through the lower magnetic pole 1 via the core 2 that connects the magnetic poles is formed for example.

As described above, the magnetic circuit can be reduced by arranging the core 2 that connects magnetic poles with the mover 8 encircled by the core and the strength of the generating unit 101 can be also enhanced. The core that connects magnetic poles is not required to be laterally symmetrical.

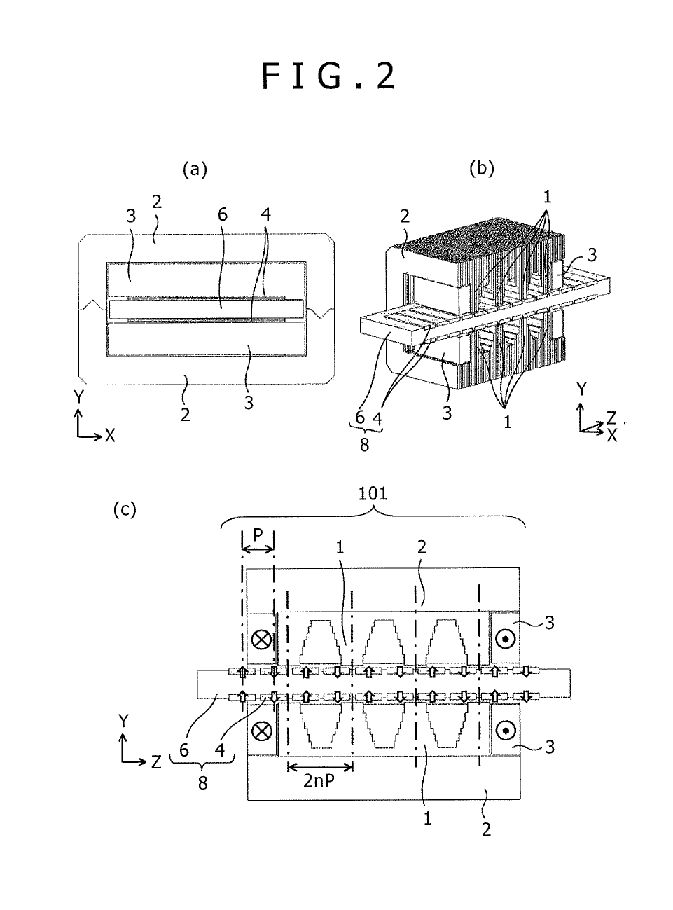

FIG. 2 show an example in which a shape of the magnetic pole 1 of the linear generator shown in FIG. 1 is tapered toward the magnet 4. FIG. 2A is a front view showing the generating unit 101. FIG. 2B is a schematic perspective view showing the generating unit 101 cut on a Y-Z plane. FIG. 2C is a schematic side view showing the generating unit 101 cut on the Y-Z plane.

As shown in FIG. 2A, the winding 3 is arranged opposite to the magnet 4 and the mover configured by the magnet 4 and the magnet holder 6 is encircled by the core 2 that connects magnetic poles. FIG. 2B shows the example in which the magnetic pole 1 is tapered toward the magnet 4. In FIG. 2B, the magnetic pole 1 is tapered toward the magnet 4; however, the present invention is not limited to this shape.

As shown in FIG. 2C, the magnet 4 is a magnet a direction of magnetization of which is the same, is arranged with the magnet holding the magnet holder 6 between, and the magnets magnetized in reverse directions are alternately arranged in a direction shown by an arrow Z. Arrows of the magnet 4 show the direction of magnetization of the magnet. Pitch of the magnetic pole 1 is substantially double, compared with pitch of the magnet arranged in the direction shown by the arrow Z.

As shown in FIG. 2C, the pitch of the magnetic pole 1 is substantially 2nP (n=1, 2, 3, . . . ), compared with the pitch P in the direction shown by the arrow Z of the magnet. In this embodiment, the magnet holder 6 is made of magnetic materials; however, the magnetic holder may be also made of non-magnetic materials.

Besides, as for the magnet 4 arranged with the magnet holding the magnet holder 6 between, magnets arranged in a direction shown by an arrow Y are integrated and may be also embedded in a ladder-type magnet holder.

In addition, as shown in FIG. 2C, when the mover 8 is reciprocated in the direction shown by the arrow Z, a magnetic flux by the magnet 4 is interlinked with the winding 3, electromotive force is generated in the winding 3, and power generation is enabled. The plural generating units 101 are arranged and a multi-phase linear generator can be also configured.

In FIG. 2, the centers of the upper and lower magnetic poles 1 arranged with the mover 8 held between them substantially coincide and the upper and lower magnetic poles are not shifted in the direction shown by the arrow Z. This state has a characteristic that force in the direction shown by the arrow Y applied to the mover 8 can be reduced because the force is vertically offset.

Further, when the ripple of force is caused because of the precision of assembly, the dispersion of characteristics of the magnet and others, the upper and lower magnetic poles 1 can be shifted so as to adjust the ripple of force.

As described above, in the linear generator according to the present invention, force applied to the mover is reduced by adjusting positions of the upper and lower magnetic poles according to a purpose.

### Second Embodiment

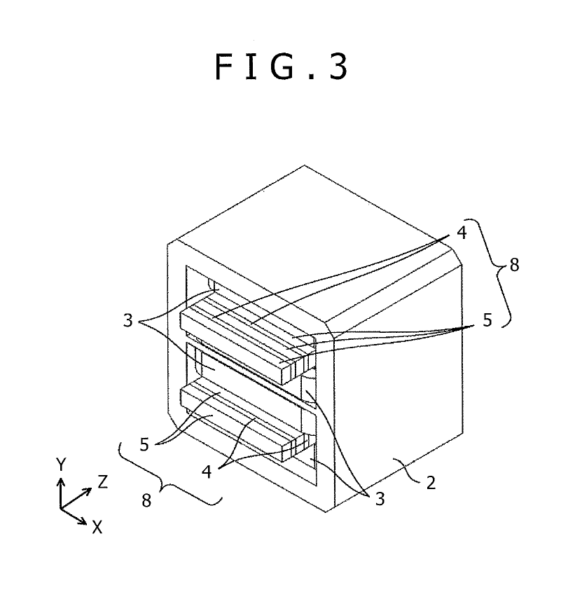

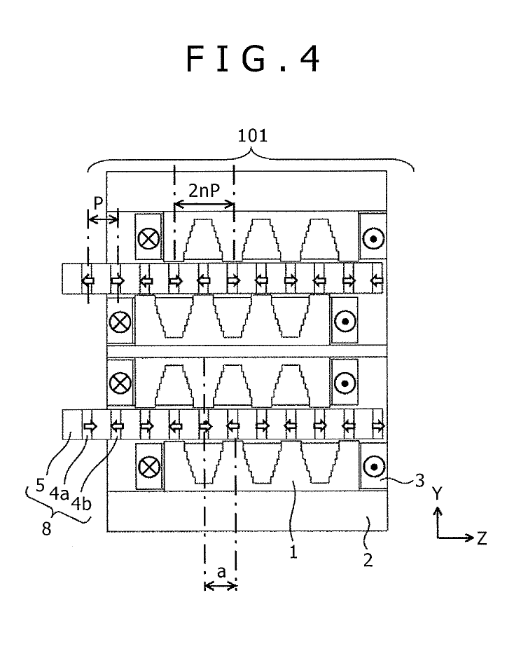

FIG. 3 is a schematic diagram showing a linear generator equivalent to a second embodiment of the present invention. FIG. 4 shows the linear generator shown in FIG. 3 and cut on a Y-Z plane.

As shown in FIG. 3, a mover 8 is configured by a magnet 4 and a magnetic pole piece 5 and the double movers 8 are provided.

Besides, in FIG. 4, arrows show directions of magnetization of the magnets. As for the magnet, a magnet 4a magnetized in a direction shown by an arrow Z (in a +Z direction) and a magnet 4b magnetized in a direction reverse to the +Z, direction (in a −Z direction) are alternately arranged in pitch P of the magnet and the pole piece 5 made of magnetic materials is arranged between each magnet. A stator configured by a magnetic pole 1, a core 2 that connects magnetic poles and winding 3 wound onto plural magnetic poles is arranged opposite to each of the double movers 8.

The magnetic pole 1 on one side of the mover 8 is arranged so that the pitch is substantially 2nP (n=1, 2, 3, . . . ) (n=1 in FIG. 4). Besides, the magnetic pole 1 opposite to upper and lower each mover 8 is vertically shifted by distance “a” substantially similar to the pitch P of the magnet.

Attraction and the moment that respectively act on the mover 8 can be offset by symmetrically arranging upper and lower linear generators as shown in FIG. 4 and mechanically coupling the upper and lower movers 8. Further, apart of the cores that connect magnetic poles of the upper linear generator and the lower linear generator can be shared and the linear generator can be also miniaturized.

Electromotive force is generated in the winding 3 by reciprocating the upper and lower movers shown in FIG. 4 in the direction shown by the arrow Z and power generation is enabled.

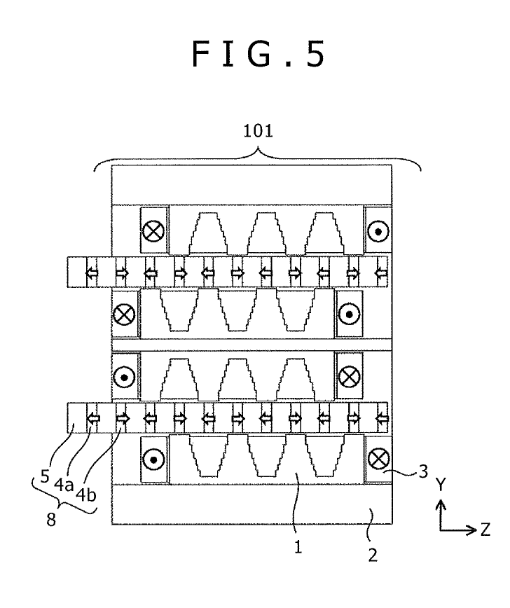

FIG. 5 shows a direction of electromotive force generated in the winding 3 when the upper and lower movers are arranged so that a direction of magnetization is the same.

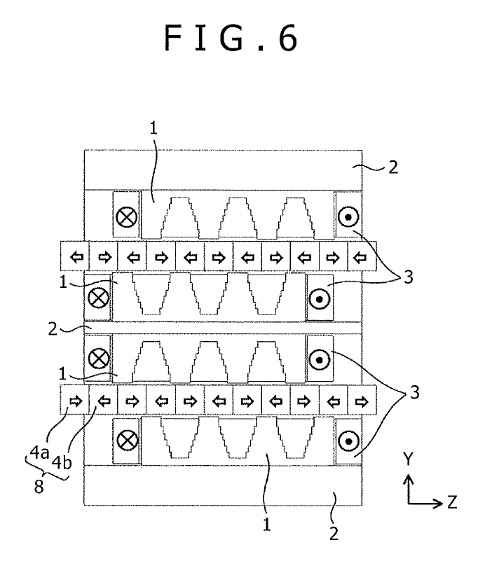

FIG. 6 shows an example in which the mover is configured by the magnet 4a and the magnet 4b. As shown in FIG. 6, the mover 8 can be configured by alternately connecting the magnet 4a and the magnet 4b.

In FIGS. 4, 5 and 6, the examples in which positions of the magnetic poles opposite to the mover are shifted substantially by the pitch of the magnet on the upside and on the downside of the mover are shown, however, the shift of the magnetic poles on the upside and on the downside of the mover is not required to be the substantial pitch of the magnet. Attraction and the moment that respectively act on the movers of the upper and lower linear generators can be offset by adjusting the shift of the upper and lower magnetic poles shifted substantially by the pitch of the magnet.

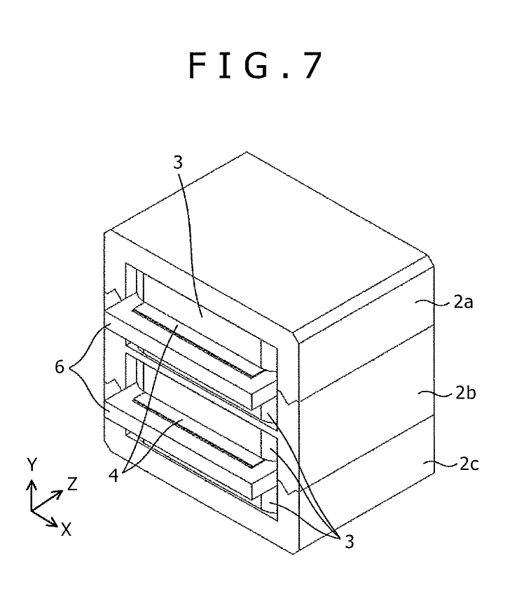

FIG. 7 shows an example in which the core that connects the magnetic poles of the double linear generators is divided in three. As shown in FIG. 7, the core that connects magnetic poles is divided into an upper divided core 2a, a lower divided core 2c and a central divided core 2b, and the upper divided core 2a and the lower divided core 2c are divided so that the upper and lower divided cores have the same shape.

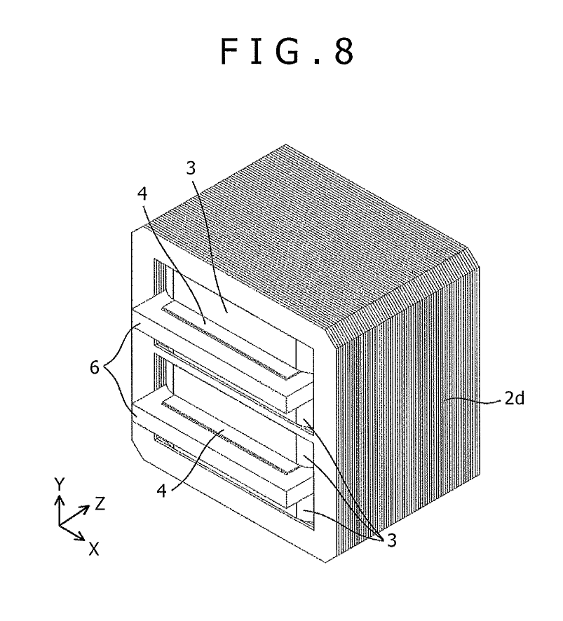

FIG. 8 shows an example in which the generator is formed by a laminated core 2d.

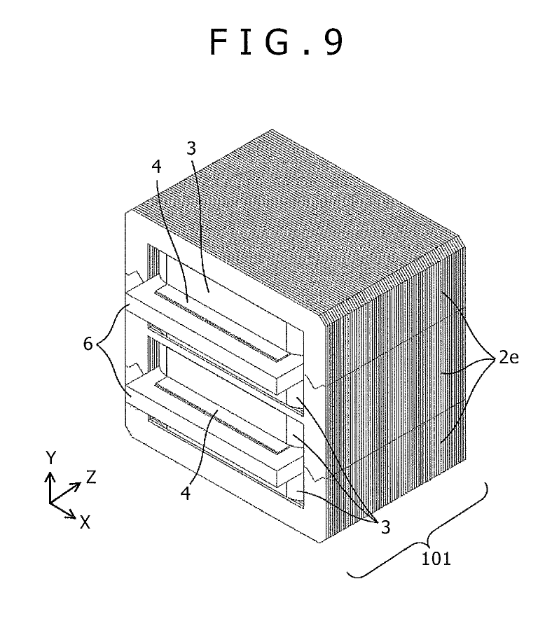

FIG. 9 shows an example in which the generator is formed by laminated divided cores 2e.

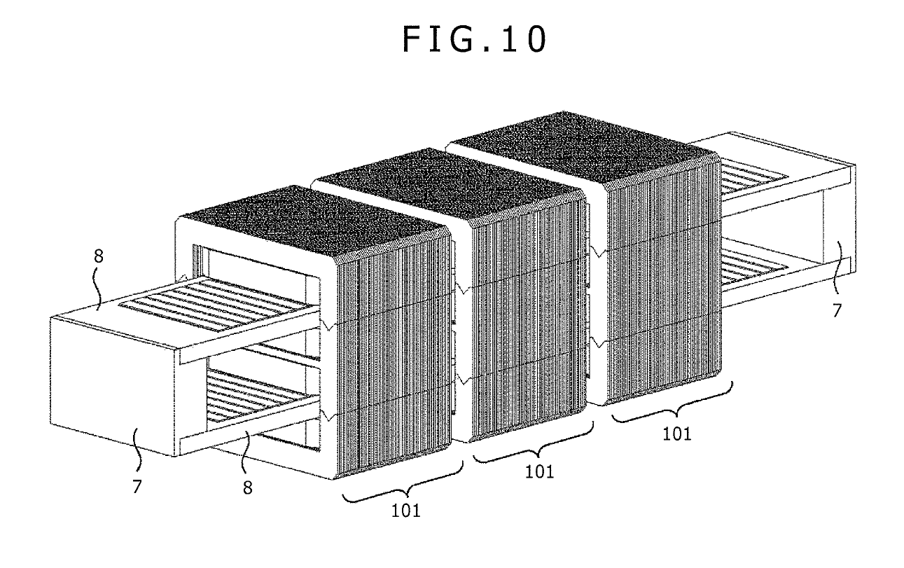

FIG. 10 shows an example in which the generating unit 101 shown in FIG. 4 is arranged by three pieces to be a three-phase linear generator. The respective generating units 101 are arranged so that respective phases are electrically shifted by 120° for a row of magnets.

Besides, ends of the movers are connected by a coupling member 7. Effects of the moment and attraction that respectively act on upper and lower each mover can be reduced by coupling the upper and lower movers as described above. In addition, the rigidity of the mover can be also enhanced.

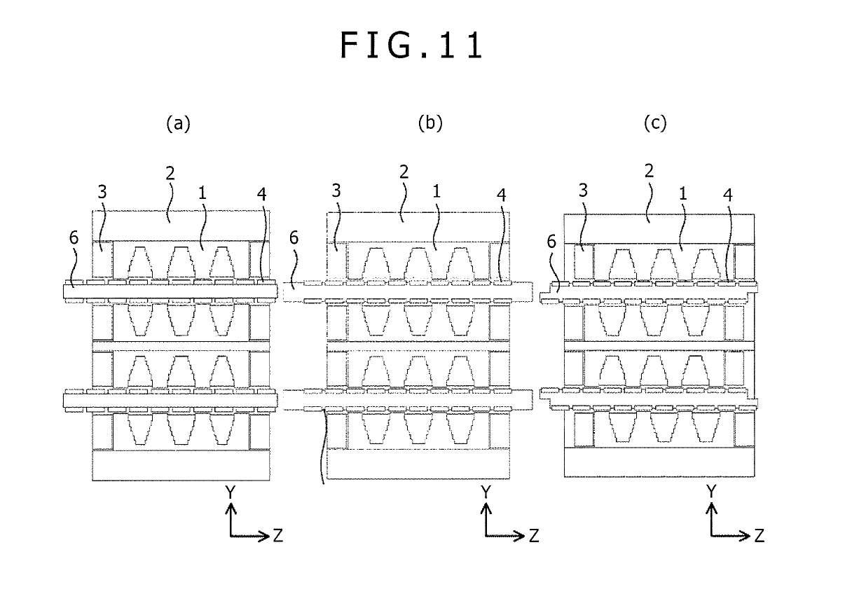

FIGS. 11A, 11B and 11C show the configurations of the linear generator according to the present invention. Each drawing of FIG. 11 shows the linear generator cut on the Y-Z plane so as to disclose the arrangement of the magnetic pole and the magnet. FIG. 11A shows structure in which the magnet 4 is bonded to a flat magnet holder 6. This structure has a characteristic that as the magnet is bonded to a flat plate made of iron and others, the productivity is satisfactory.

In FIG. 11B, a groove for arranging the magnet is worked on the magnet holder 6 and there is a projection 9 between magnets arranged in a direction shown by an arrow Y. When the projection 9 is made of magnetic materials, effect that a magnetic flux interlinked with the winding 3 increases is acquired. Besides, the magnet holder 6 and the projection 9 may be also integrated and may be also formed by separate members. When the projection 9 is provided, a concave portion can be also utilized for a groove for positioning the magnet 4.

FIG. 11C shows an embodiment in which the magnetic pole 1 that holds the mover between and the core 2 that connects magnetic poles are shifted by shifting upper and lower cores for the mover and besides, the positions of the magnet of the mover are shifted on a surface and at the back of the magnet holder 6. As described above, the positions of the magnet can be also shifted on the surface and at the back of the mover.

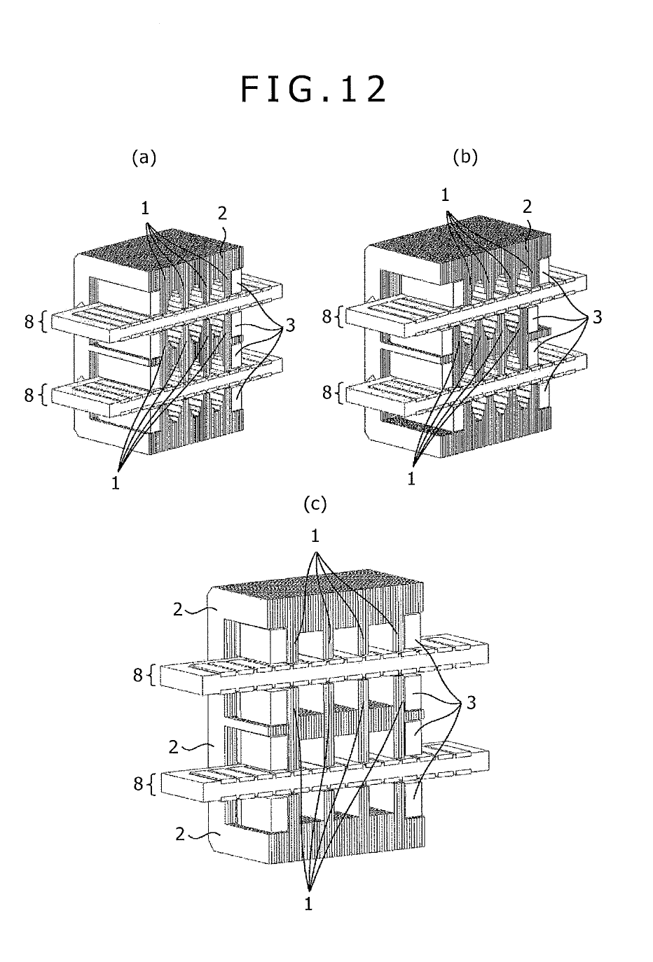

FIG. 12 show the linear generator partially cut so as to disclose the configuration of the magnetic pole 1 and the core 2 that connects magnetic poles. FIG. 12 show an example in which the magnetic pole 1 and the core 2 that connects magnetic poles of the linear generator according to the present invention are formed by overlapping laminated steel plates.

FIG. 12A shows that the upper and lower magnetic poles 1 are aligned via the mover 8 in a traveling direction of the mover 8. FIG. 12B shows an example in which the upper and lower magnetic poles 1 are shifted via the mover 8 in the traveling direction of the mover. FIG. 12C shows an example in which a shape of the magnetic pole 1 is rectangular.

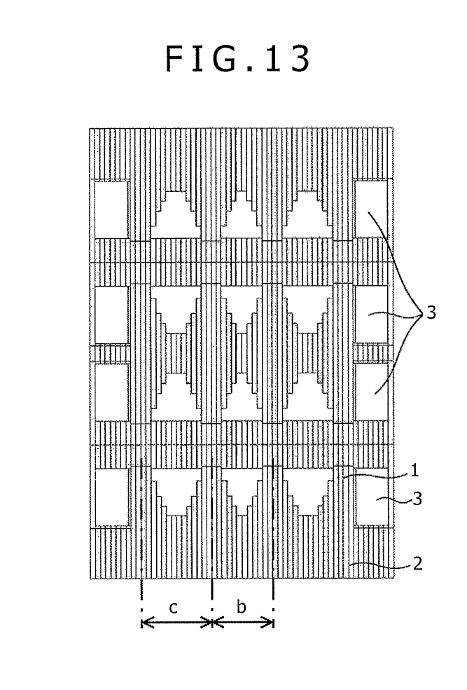

FIG. 13 shows an example in which the linear generator is formed by a laminated steel plate. To disclose the inside of the linear generator, the generator is cut in the traveling direction of the mover. FIG. 13 shows only a stator configured by the magnetic pole 1, the core 2 that connects magnetic poles and the winding 3.

The pitch of the magnetic pole 1 can be arbitrarily adjusted by adjusting the number of the laminated steel plates because the magnetic pole 1 and the core 2 that connects magnetic poles are made of the laminated steel plates. The position of the magnetic pole 1 can be adjusted by varying the number of the laminated steel plates as shown by the pitch b of the magnetic pole and the pitch c of the magnetic pole. The pitch b of the magnetic pole is formed by twelve laminated steel plates and the pitch c of the magnetic pole is formed by fourteen laminated steel plates.

### Third Embodiment

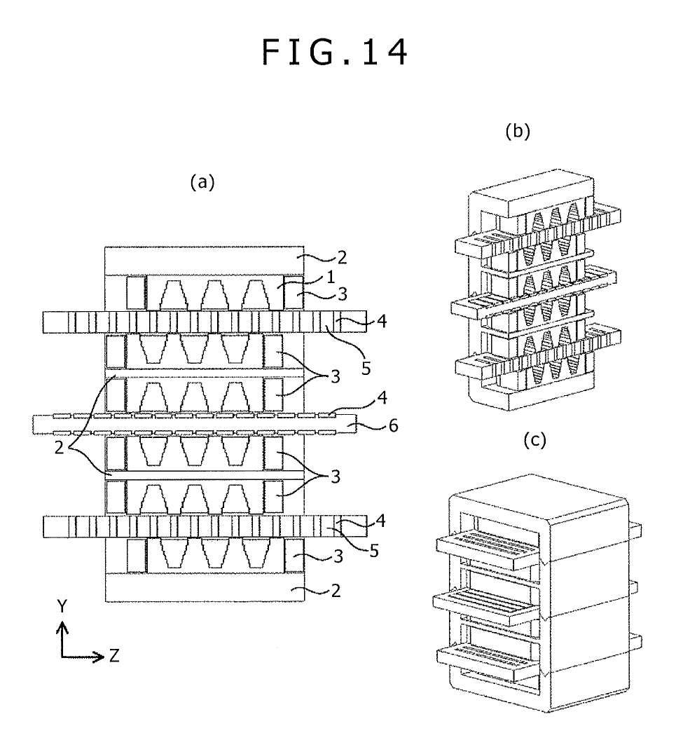

FIG. 14 show a third embodiment of the present invention.

FIG. 14 show the embodiment in which the linear generator shown in FIG. 2 is combined between the linear generators shown in FIG. 4. FIG. 14A shows a linear generator cut on a Y-Z plane.

FIG. 14B is a perspective view showing the linear generator shown in FIG. 14A. FIG. 14C is a perspective view showing the linear generator. As the generated moment is mutually directed in reverse directions in the uppermost linear generator and the lowermost linear generator respectively shown in FIG. 14, the moment is offset and can be reduced.

Besides, in a central linear generator, upper and lower magnetic poles are symmetrical via a mover and the moment that acts on the central mover is not much. The moment and attraction in a direction shown by an arrow Y can be mutually reduced by coupling these three movers.

In this embodiment, triple mover structure is described; however, multi-stage structure in which further more movers are provided can be also formed by arranging so that the moment and attraction are reduced.

Besides, as directions of magnetic fluxes are reverse in the core that connects the magnetic poles in the uppermost, the central and the lowermost linear generators respectively shown in FIG. 14 and magnetic saturation is relaxed, the core can be thinned and as a result, the generating unit is also miniaturized.

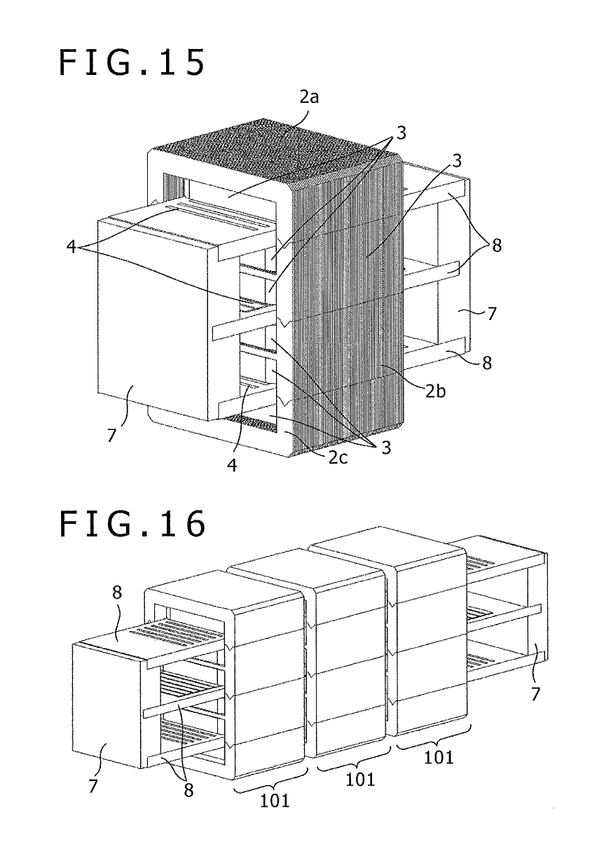

FIG. 15 shows that the individual movers 8 in the linear generators shown in FIG. 14 are mechanically fastened. As described above, the individual movers 8 may be also coupled.

FIG. 16 shows a three-phase linear generator acquired by arranging the linear generator shown in FIG. 15 by three.

### Fourth Embodiment

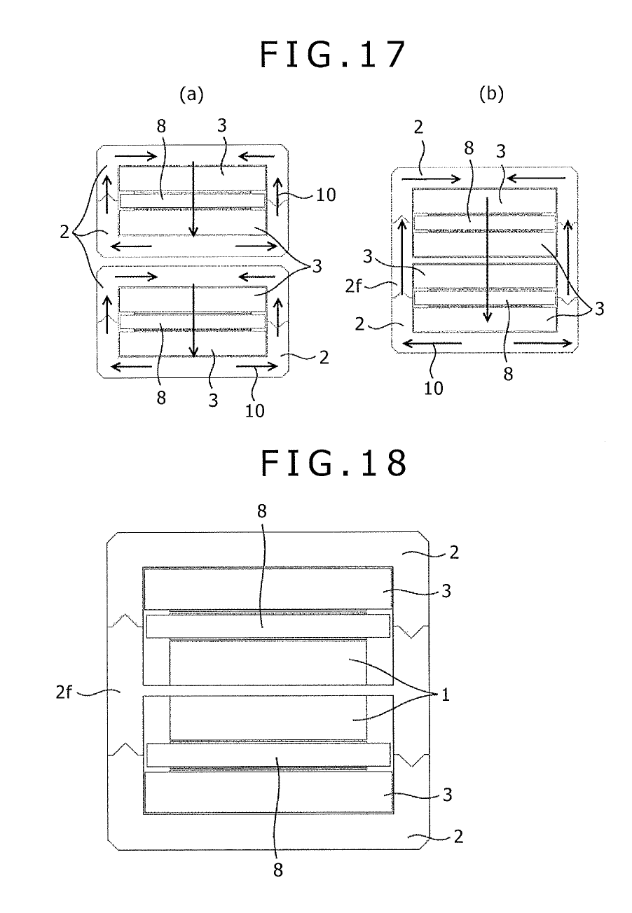

FIG. 17 are front views showing a two-stage linear generator and schematically show a magnetic flux 10 generated by a magnet. FIG. 17A is the front view showing upper and lower individual linear generators. FIG. 17B shows directions of magnetic fluxes when the two generators are combined.

The miniaturization of the linear generator is enabled by sharing a core 2 that connects a lower magnetic pole of the upper generator and a core 2 that connects an upper magnetic pole of the lower generator in the two generators shown in FIG. 17A to be a core 2f which is shown in FIG. 17B and which connects magnetic poles.

### Fifth Embodiment

FIG. 18 shows a linear generator in which double movers 8 are built. FIG. 18 shows an example in which winding 3 is arranged on the upside of the upper mover 8 and on the downside of the lower mover 8. As described above, a position and the number of the winding 3 are not limited to those described in this embodiment.

### Sixth Embodiment

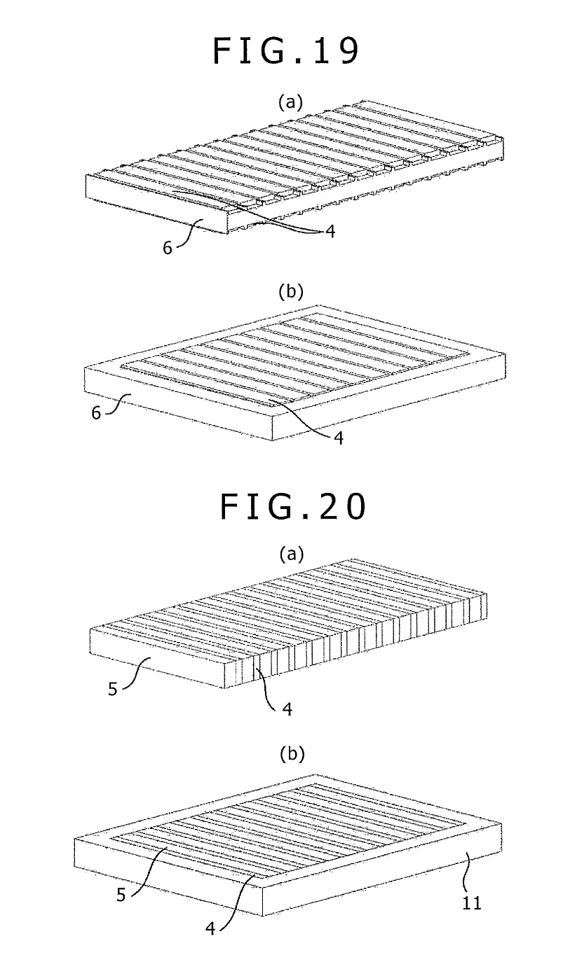

FIGS. 19 and 20 show embodiments of a mover according to the present invention. FIG. 19A shows an example in which a groove is made on a flat magnet holder 6 and a magnet 4 is bonded. FIG. 19B shows an example in which a concave portion is provided to the magnet holder 6 and the magnet 4 is arranged.

FIG. 20A shows an example in which the mover is formed by only the magnet 4 and a pole piece 5. FIG. 20B shows the embodiment in which the mover shown in FIG. 20A is encircled by a frame 11 to increase the strength. The frame 11 can be made of magnetic materials and can be also made of non-magnetic materials.

The linear generator according to the present invention generates power with vibrational energy in running by coupling it to an automobile tire and can be also used for a tidal power generator or a wave activated power generator utilizing the energy of a wave for example.

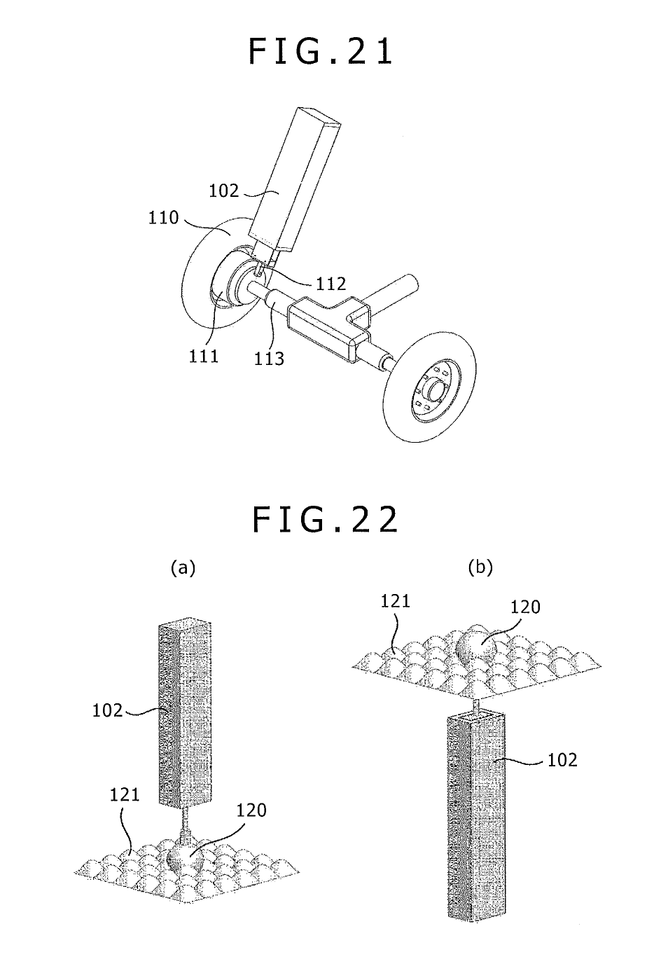

FIG. 21 shows an example in which the linear generator according to the present invention is connected to an automobile tire. A wheel 111 and a tire 110 are coupled to a shaft 113. A linear generator 102 is coupled to the wheel 111 via a link 112. Power generation is enabled by the energy of a rotational motion of the tire 110.

In FIG. 21, the link 112 is connected to the wheel 111; however, if only the kinetic energy of the tire can be transmitted to the linear generator 102, the configuration may be also any configuration. Besides, the linear generator can be also mounted on suspension or a damper of an automobile.

FIG. 22 show examples in which a wave activated power generator is configured by the linear generator according to the present invention. FIG. 22A shows an example in which the linear generator 102 is installed on the sea. FIG. 22B shows an example in which the linear generator 102 is installed in the sea.

FIG. 22 show configuration that a buoy 120 is coupled to the linear generator 102, a mover of the linear generator performs a linear motion by the buoyancy of the buoy 120 and power generation is made. An electricity-generating system that uses the linear generator according to the present invention is not limited to the configuration of power generation shown in FIG. 22, can be configured by transmitting ups and downs of a water surface by wave force and tidal force to the linear generator according to the present invention, and if only the similar effect is acquired, any configuration is allowed.

### Seventh Embodiment

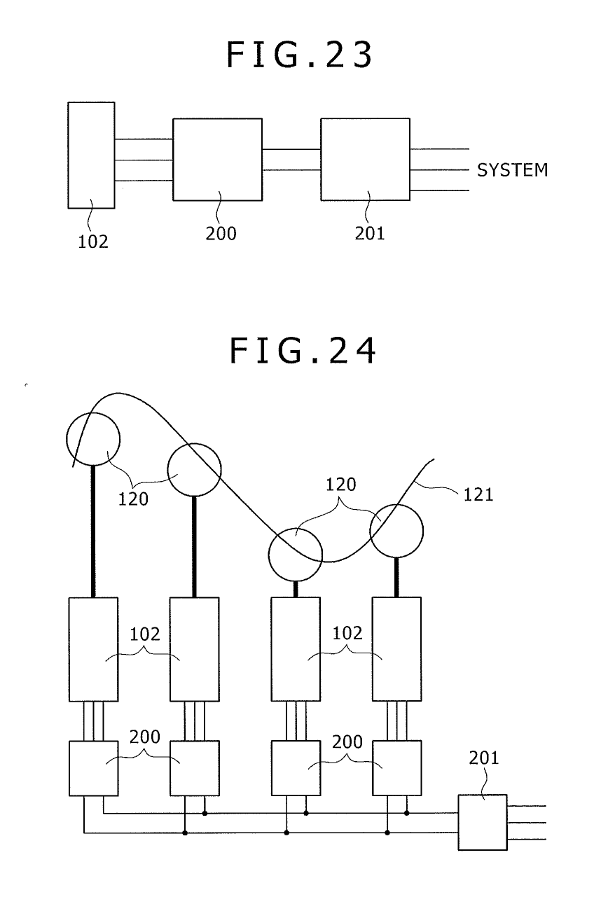

FIG. 23 shows a seventh embodiment of the present invention. A linear generator 102 according to the present invention is connected to a three-phase converter.

Three-phase current generated by the linear generator is converted to direct current by the three-phase converter 200.

A DC/AC inverter 201 is connected to the three-phase converter 200, the direct current is converted to be a fixed frequency by the DC/AC inverter and the DC/AC inverter is connected to a system. A frequency of alternating current generated by narrowing the pitch of a magnetic pole can be increased by using the linear generator according to the present invention and the efficiency of power generation can be enhanced.

Further, as a leakage flux is lessened, an ineffective magnetic flux is reduced and the inductance can be reduced. As the inductance can be reduced, the capacity of the converter is reduced and a small-sized electricity-generating system can be provided. Further, as a load of a supporting mechanism can be reduced, the frequency of maintenance can be reduced.

In FIG. 23, the example of the three-phase linear generator and the three-phase system is shown; however, the present invention is not limited to this configuration.

### Eighth Embodiment

FIG. 24 is an explanatory drawing for explaining an eighth embodiment of the present invention. FIG. 24 shows an electricity-generating system utilizing wave force. A three-phase converter 200 is connected to a linear generator 102 to a mover of which a buoy 120 is connected and each three-phase converter 200 is connected to a system via a DC/AC inverter 201.

As the height of a wave 121 temporally varies, alternating current generated in the linear generator 102 also has a waveform of a sine wave. The velocity of the buoy 120 installed in the linear generator 102 is zero in a location in which the wave is the highest and the quantity of power generated by each linear generator 102 temporally varies.

Then, the quantity of generated power can be smoothed by arranging the plural linear generators 102 in a traveling direction of the wave in parallel or in a box type. In this system configuration, the three-phase converter 200 is required for each linear generator 102, however, in the linear generator 102 according to the present invention, as the inductance can be reduced by the reduction of a leakage flux in addition to effects that the pitch of the magnetic pole is narrowed, a frequency of generated alternating current is increased and the efficiency of power generation can be enhanced, the capacity of the converter can be also reduced. Further, as a load onto a supporting mechanism is reduced, the supporting mechanism can be miniaturized and as a result, the whole system can be miniaturized.

In the embodiment of the present invention, the example that the shapes of the magnetic pole, the core that connects magnetic poles and the mover are changed is described, however, if only the similar effect is acquired, the present invention is not limited to the shapes.

For the magnetic materials described in this embodiment, iron material such as SS400 and S45C and a member the magnetic ratio of which is high such as a silicon plate can be utilized.

The movers described in the embodiments of the present invention are supported by a thrust bearing, an LM guide, a roller and others and a void between the magnetic pole and the mover can be held.

The cores that connect the magnetic pole and the magnetic pole according to the present invention may be also integrated.

### LIST OF REFERENCE SIGNS

1 Magnetic pole
2 Core that connects magnetic poles
2a Upper divided core
2b Central divided core
2c Lower divided core
2d Laminated core
2e Laminated divided core
3 Winding
4 Magnet
4a Right-oriented magnet
4b Left-oriented magnet
5 Pole piece
6 Magnet holder
7 Coupling member
8 Mover
9 Projection
10 Magnetic flux
11 Frame
101 Generating unit
102 Linear generator
110 Tire
111 Wheel
112 Link
113 Shaft
120 Buoy
121 Wave
200 Three-phase converter
201 DC/AC inverter

1. A linear generator, comprising:
a plurality of magnetic poles arranged with a mover where the polarity of magnets is alternately arrayed held between the plurality of magnetic poles;
winding similarly wound onto the plurality of magnetic poles arranged with the mover held between the plurality of magnetic poles; and
a core that connects the plurality of magnetic poles.

2. A linear generator, comprising:
a plurality of magnetic poles arranged with a mover where the polarity of magnets is alternately arrayed held between the plurality of magnetic poles;
winding similarly wound onto the plurality of magnetic poles arranged with the mover held between the plurality of magnetic poles; and
a core that connects the plurality of magnetic poles, wherein:
force which acts on the mover in directions except a traveling direction of the mover is offset.

3. The linear generator according to claim 1, wherein:
the magnetic poles are arranged in a state in which the pitch of the magnetic pole is substantially 2nP (n=1, 2, 3, . . . ), compared with the pitch P of the magnet in the traveling direction of the mover.

4. The linear generator according to claim 1, wherein:
a member that functions as the core that connects the magnetic pole and the magnetic pole is divided.

5. The linear generator according to claim 1, wherein:
the magnetic pole, the core that connects magnetic poles and the member configured by them are formed by a member laminated in the traveling direction of the mover.

6. The linear generator according to claim 1, wherein:
the plurality of magnetic poles arranged with the mover held between the plurality of magnetic poles are shifted in the traveling direction of the mover.

7. The linear generator according to claim 1, comprising:
a plane on which the magnetic pole and a surface of the magnet are opposite, wherein:
the mover pierces a stator configured by the magnetic pole and the core that connects magnetic poles.

8. The linear generator according to claim 1, comprising:
the mover where the magnets are arranged on an upper surface and on the back of a magnetic body provided with the plane.

9. The linear generator according to claim 8, wherein:
a convex portion of the magnetic body is provided between the magnets arranged in the traveling direction of the mover.

10. The linear generator according to claim 8, wherein:
positions of the magnets arranged on the upper surface and on the back of the magnetic body of the mover are shifted between the upper surface and the back in the traveling direction of the mover.

11. The linear generator according to claim 1, comprising:
two or more movers, wherein:
the two or more movers are arranged with the movers symmetrical based upon the axis in the traveling direction of the mover.

12. The linear generator according to claim 11, wherein:
the two or more movers are coupled.

13. A generating unit, wherein:
the linear generator according to claim 1 is used.

14. A linear electricity-generating system, comprising:
the linear generator according to claim 1;
a converter that converts generated energy to direct current; and
a DC/AC inverter that converts the direct current to alternating current.

15. Electromagnetic suspension for a vehicle, wherein:
the linear generator according to claim 1 is used.

16. An electricity-generating system for wave activated power generation, wherein:
the linear generator according to claim 1 is used.

17. The linear electricity-generating system according to claim 14, wherein:
a plurality of linear generators are arrayed.
